(19) United States
(12) Patent Application Publication
(10) Pub. No.: US 2005/0226964 A1
(43) Pub. Date: Oct. 13, 2005

(54) Water soluble seal and cap

(76) Inventors: Michael Small, East Islip, NY (US); Bruce J. Duhan, Spring Valley, NY (US)

Correspondence Address: WILLIAM COLLARD;COLLARD & ROE, P.C., 1077 NORTHERN BOULEVARD, ROSLYN, NY, 11576, US

(21) Appl. No.: 10/819,731

(22) Filed: Apr. 7, 2004

(51) Int. Cl. A23B 4/00

(52) U.S. Cl. 426/115

(57) ABSTRACT

A device for adding flavor to a fluid comprising includes a housing which also includes a enhancement disposed in the housing. To keep this fluid inside the housing there is a fluid soluble seal covering the enhancement in the housing wherein the housing can be coupled to a container which contains a fluid. This fluid can be mixed with the fluid soluble seal to cause the fluid soluble seal to dissolve. Once the fluid soluble seal dissolves, the enhancement then mixes with the fluid to flavor the fluid.

### BACKGROUND OF THE INVENTION

### Field of the Invention

The present invention relates to a fluid flavoring device which can be coupled with a fluid to easily flavor the fluid. One example of this is a bottle top which has a flavoring substance sealed therein by a water soluble seal.

Fluid flavoring devices are known in the art. For example, U.S. Pat. Nos. 6,167,687; 5,827,586; 6,484,879; 6,527,110; 6,527,109; 6,540,070; 6,372,270; 6,170,654; 6,165,523; 6,152,296; 4,221,291; 4,195,730 all incorporated herein by reference. In addition, the following two U.S. applications are also known in the art, U.S. Application publication No. 2002/0157970 and 2002/0066677 both incorporated herein by reference.

In addition, water soluble strips are known in the art such as Listerine® strips which may contain one or more of the following ingredients: Pullulan, Flavors, Menthol, Aspartame, Potassium Acesulfame, Copper Gluconate, Polysorbate 80, Carrageenan, Glyceryl Oleate, Eucalyptol, Methyl Salicylate, Thymol, Locust Bean Gum, Propylene Glycol, Xanthan Gum, FD&C Green No 3. In addition this type of information may be disclosed in U.S. Pat. No. 6,596,298 issued on Jul. 22, 2003 wherein this patent is incorporated herein by reference. In addition, additional information relating to Pullulan based substances has been disclosed in U.S. Pat. Nos. 5,411,945 and 5,518,902 both to Ozaki et al and both incorporated herein by reference.

### SUMMARY OF THE INVENTION

A device for adding flavor to a fluid which includes a housing which also includes a flavoring disposed in the housing. To keep this flavoring, vitamins, minerals, or any other nutritional enhancements inside the housing there is a fluid soluble seal covering the flavoring, in the housing wherein the housing can be coupled to a container which contains a fluid. This fluid can be mixed with the fluid soluble seal to cause the fluid soluble seal to dissolve. Once the fluid soluble seal dissolves, the flavoring then mixes with the fluid to flavor the fluid.

The flavoring can be in granular, crystalline, powder or solid form. The fluid soluble seal can be formed from at least 1 wt % Pullulan.

This device can also include an adapter coupled to the housing wherein this adapter is for coupling the housing to the fluid container. This adapter can comprise a channel which extends out from, and is formed integral with the housing. This adapter can also comprise a plurality of threads formed along this channel which then allow the housing to be screwed onto a bottle.

There can also be additional non-soluble seal coupled to this adapter for sealing off said threaded channel. This additional seal can comprise a tab and can be placed at an opening of the housing. This non fluid soluble seal covers the fluid soluble seal so that the fluid soluble seal does not accidentally dissolve prematurely.

In addition, a second fluid soluble seal can be placed between the first fluid soluble seal and the non-soluble seal as well. In between this second fluid soluble seal and the first fluid soluble seal can be an additional flavoring that is different than the flavoring trapped inside of the housing by the first fluid soluble seal.

In this way, users of this device can have the additional effect of a flavoring in their water in an easy and simplified manner.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a side cut-away view of the device for adding flavor to a fluid;

FIG. 2A is a side view of device shown in FIG. 1 with the housing shown in a cut-away view;

FIG. 2B is a perspective view of the device shown in FIG. 1; and

FIG. 2C shows a perspective view of the device shown in FIG. 1, wherein this perspective view shows a transparent housing revealing the water soluble seal and the additional seal.

### DETAILED DESCRIPTION OF PREFERRED EMBODIMENTS

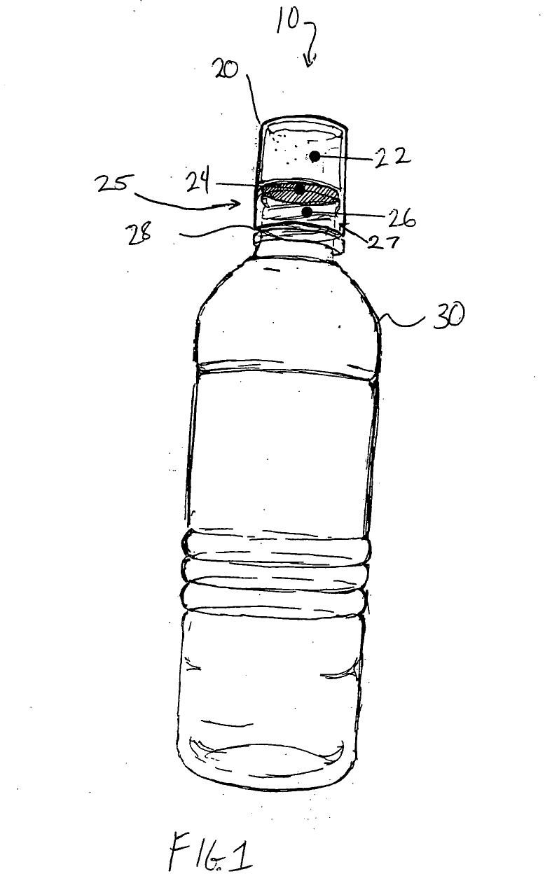

Turning now in detail to the drawings, FIG. 1 discloses a side perspective view of a device 10 for adding flavor to a fluid. This device includes a housing 20 which is coupled to a bottle 30. In this case, bottle 30 can be a water bottle. Housing 20 can be cylindrically shaped and formed essentially as a bottle top or a bottle cap. Disposed inside housing 20 is an enhancement 22 which can be a flavoring enhancement or a nutritional enhancement which is fluid soluble, particularly water soluble. Enhancement 22 can be in a granular powder or crystalized form or even in a solid form. There is also a fluid soluble seal 24 covering this enhancement 22 wherein the fluid soluble seal can be formed from at least one weight percent Pullulan material. This fluid soluble seal is designed so that when fluid contacts the fluid soluble seal, the fluid soluble seal would dissolve and allow the concentrated enhancement to be accessed by a fluid that is in a container or bottle 30. Fluid soluble seal 24 extends across an entire open diameter of housing 20 so that it traps enhancement content in cap or housing 20. In this case, the user can couple or attach the device or bottle top to a bottle allowing fluid to contact fluid soluble seal 24, thereby dissolving the fluid soluble seal and allowing the concentrate to be accessed by the fluid to flavor the fluid.

Disposed adjacent to the fluid soluble seal is an adapter 25 which is essentially formed integral with housing 20 and extending out therefrom the housing. This adapter 25 includes a series of threads 26 which extend along a channel 27 to an open end in region 28. This threaded region allows the adapter to be coupled to a bottle and screwed onto a bottle so that it can be secured to a bottle.

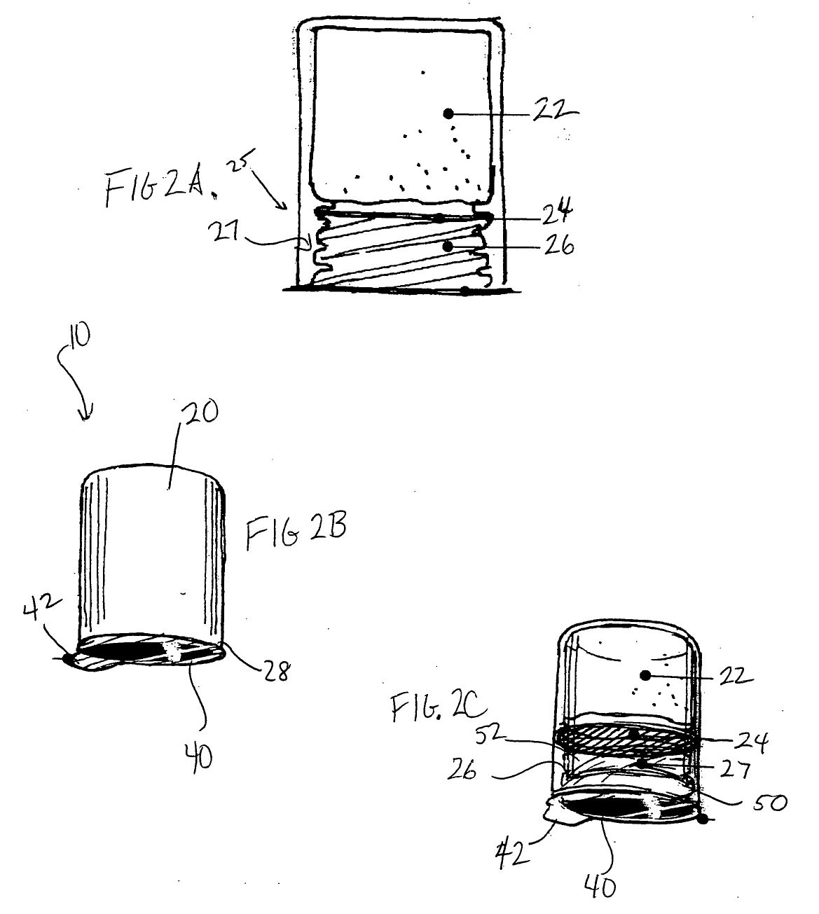

FIG. 2A shows a side partially exposed view of device 10 which includes housing or cap 20 and enhancement 22 disposed inside cap 20. This view also shows a close-up view of adapter 25 which includes the extended channel 27 and also threads 26.

FIG. 2B discloses a bottom perspective view of device 10 which includes housing 20 which extends out to end 28 and which is thereby covered by an additional seal 40 which can be cemented or glued onto end part 28. Additional seal 40 can essentially be a non-water soluble seal such as a foil which is coupled to end 28 via any ordinary glue or adhesive material. In this way, additional seal 40 can completely cover an opening to housing 20 to keep fluid from prematurely dissolving seal 24 and to also deter product tampering.

However, to use the device, the user can then peel away seal or covering 40 using a tab 42 before placing this device on a bottle.

FIG. 2C shows a side transparent view of the different layers of the different possible seals in the device. In this case, for two separate enhancements, such that there is a first water soluble seal 24 which covers first enhancement 22 and also a second water soluble seal 50 which covers a second enhancement 52. Both of these enhancements are then covered by then non-water soluble seal 40 which is then coupled to outer surface 28 of housing or cap 20.

Thus, in use, when a user decides to use the bottle cap, the user can peel away seal 40 using tab 42 to expose an open end of housing or cap 20 wherein this open end starts with end 28 on cap 20. In this case, the user can then screw on cap or housing 20 to a fluid filled bottle such as a water bottle or any other bottle shown in FIG. 1. Once the cap is screwed on using threads 26, a user can then shake the bottle causing fluids to splash or flow up to a water soluble seal such as first water soluble seal 24 in a first embodiment, or to both first and second water soluble seals 24 and 50 in a second embodiment such as that shown in FIG. 2C. Once these water soluble seals have been compromised or dissolved, the enhancement, which can be in a semi-solid, powder or crystalized form, would then mix with the fluid disposed in the bottle and then eventually dissolve into the fluid to create a flavored drink. Thus, this design would make it easier and more convenient for users to flavor their drinks. The enhancements may be in the form of a nutritional enhancement such as vitamins A, B, C, etc. minerals such as zinc, chromium, iron, calcium etc. or in the form of an herbal remedy such as echinacea, tyrosine, bee pollen, Ginseng, amino acids such as glucosamine or MSM, or proteins such as whey powder.

In addition, the enhancements could be in the form of medicinal enhancements such as aspirin, or other known pain relievers, stomach relievers, allergy medicines or any other medicinal remedies. In addition as stated above the enhancements may be in the form of a flavoring enhancement such as a granular or crystallized lemon flavoring for lemonade, a grape flavoring, strawberry, mint, cherry, lime, or any other type flavoring.

For example, one type of design could include two different flavorings with the first enhancement being lemon, and the second enhancement being lime. When the cap is applied to the bottle, the first water soluble seal dissolves dissolving a green lime flavoring first. Next, the second water or fluid soluble seal would dissolve allowing the yellow colored granular lemon flavoring to fall into the bottle of water and dissolve. In that way the user would be able to see the mixing of these two different flavorings in the bottle.

The different types of enhancements mentioned above are listed by way of example. Thus, this invention is not limited to any of those particular examples described above. Any type of granular, powdered or crystallized enhancement may be used. Because these enhancements are in the form of particles, they can fall into or be mixed with the liquid solution disposed in an attached bottle. Because these enhancements are in the form of separate particles their relatively large surface area/volume ratio allows these particles to mix with the associated liquid and dissolve more rapidly than a solid flavoring or enhancement.

Accordingly, while a few embodiments of the present invention have been shown and described, it is to be understood that many changes and modifications may be made thereunto without departing from the spirit and scope of the invention as defined in the appended claims.

1. A device for adding flavor to a fluid comprising:
a) a housing;
b) an enhancement disposed in said housing; and
c) a fluid soluble seal covering said enhancement in said housing wherein said housing can be coupled to a container which contains a fluid, wherein said fluid can be mixed with said fluid soluble seal to cause said fluid soluble seal to dissolve, wherein said enhancement then mixes with said fluid to flavor said fluid.

2. The device as in claim 1, wherein said enhancement is in a granular form.

3. The device as in claim 1, wherein said enhancement is in a powder form.

4. The device as in claim 1, wherein said enhancement is in a crystalized form.

5. The device as in claim 1, wherein said fluid soluble seal is formed from at least 1 wt % Pullulan binder.

6. The device as in claim 1, further comprising an adapter coupled to said housing wherein said adapter is for coupling said housing to said fluid container.

7. The device as in claim 1, wherein said adapter comprises a channel which extends out from, and is formed integral with said housing.

8. The device as in claim 1, wherein said adapter further comprises a plurality of threads formed along said channel.

9. The device as in claim 7, further comprising an additional seal coupled to said adapter for sealing off said threaded channel.

10. The device as in claim 9, wherein said additional seal comprises a tab.

11. The device as in claim 1, wherein said housing is in a cylindrical shape.

12. A device for adding flavor to a fluid comprising:
a) a substantially cylindrical housing;
b) a granular enhancement disposed in said housing;
c) a fluid soluble seal covering said enhancement in said housing; and
d) a non-fluid soluble seal having a tab and coupled to said housing to cover an open end of said housing wherein said non fluid soluble seal can be removed from said housing via said tab, and wherein said housing can be coupled to a container which contains a fluid, wherein said fluid can be mixed with said fluid soluble seal to cause said fluid soluble seal to dissolve, wherein said granular enhancement then mixes with said fluid to flavor said fluid.

13. A device for adding flavor to a fluid comprising:
a) a substantially cylindrical housing forming a top with a closed end and an open end;
b) a first granular enhancement disposed in said housing between said fluid soluble seal and said closed end of said substantially cylindrical housing;
c) a first fluid soluble seal covering said first granular enhancement in said housing, keeping said first granular enhancement between said fluid soluble seal and said closed end of said substantially cylindrical housing;
d) a second fluid soluble seal coupled to said housing and spaced apart from said first fluid soluble seal;
e) a second granular enhancement disposed in said housing between said first soluble seal and said second soluble seal; and
f) a non-fluid soluble seal having a tab and coupled to said open end of said housing to cover said open end of said housing wherein said non fluid soluble seal can be removed from said housing via said tab, and wherein said housing can be coupled to a container which contains a fluid, wherein said fluid can be mixed with said second fluid soluble seal to cause said additional fluid soluble seal to dissolve, wherein said second granular enhancement then mixes with said fluid to flavor said fluid, next said fluid mixes with said first fluid soluble seal to dissolve said first fluid soluble seal to cause said first granular enhancement to mix with said fluid.

14. The device as in claim 13, wherein at least one of said first granular enhancement and said second granular enhancement is in the form of a flavoring.

15. The device as in claim 13, wherein at least one of said first granular enhancement and said second granular enhancement is in the form of a vitamin.

16. The device as in claim 13, wherein at least one of said first granular enhancement and said second granular enhancement is in the form of an herbal remedy.
